(19) United States
(12) Patent Application Publication
(10) Pub. No.: US 2019/0277197 A1
(43) Pub. Date: Sep. 12, 2019

(54) GAS TURBINE ENGINE FOR BLOCK LOADING POWER CONTROL

(71) Applicant: ICR Turbine Engine Corporation, Hampton, NH (US)

(72) Inventors: James B. Kesseli, Greenland, NH (US); Thomas L. Wolf, Winchester, MA (US)

(21) Appl. No.: 16/298,859

(22) Filed: Mar. 11, 2019

Related U.S. Application Data
(60) Provisional application No. 62/641,119, filed on Mar. 9, 2018.

(51) Int. Cl. F02C 6/16; F01D 17/16; F02C 3/04; F02B 37/24; F01D 15/10; H02J 3/06

(52) U.S. Cl. CPC F02C 6/16; F01D 17/165; H02J 3/06; F02B 37/24; F01D 15/10; F02C 3/04

(57) ABSTRACT

An apparatus and method are disclosed that enable a multi-spool gas turbine engine to produce ISO-qualified power quality during block loading, while also achieving high efficiency over a wide power range. Such an engine would enable new markets, including modern data centers, to operate independently from the utility grid, while achieving high efficiency, reliability, and power quality. The engine includes a variable area nozzle upstream of the free power turbine. On experiencing the torque spike, the variable area nozzle is opened rapidly to provide rapid an increase in air flow aspirated by the engine. When combined with a proportionally increased fuel supply, the power and torque of the free power turbine increases with a time constant close to that of the fuel valve and variable area nozzle movement. Coupling a variable speed alternator to the free power turbine, and coupling the rectified alternator output to an inverter serves to isolate the speed change of the alternator from the frequency delivered to the power grid.

### CROSS REFERENCE TO RELATED APPLICATION

The present application claims the benefits, under 35 U.S.C.§ 119(e), of U.S. Provisional Application Ser. No. 62/641,119 entitled “Gas Turbine for Block Loading” filed Mar. 9, 2018 which is incorporated herein by reference.

### FIELD

The present disclosure relates generally to the field gas turbine power generation and specifically to control of electrical power output as applied to off-grid electric power generation.

### BACKGROUND

Gas turbines are commonly configured with generators and used to provide off-grid power generation. There two general architectures: single shaft engines (FIGS. 1 and 2) and two or three-shaft engines (FIG. 3), the latter also known as free-power turbine engines. Single shaft engines are recognized to have excellent transient behavior under so-called block-loading conditions, while free-power turbine engines are known to have poor transient behavior and thus not favored for off-grid power generation. Neither gas turbine is particularly efficient under part-load conditions, but the single shaft engine is especially poor. New market applications for distributed power generation are intended to operate over a significant fraction of the year while disconnected from their utility grid (“the grid”) and face the dilemma of having poor part-load efficiency if they are expected to also meet the International Standards Organization's (ISO) strict requirements for power quality. The gas turbine engine architecture disclosed herein is designed to enable excellent, ISO-qualified power quality during block loading, while also achieving high efficiency over a wide engine power range. Such an engine would enable new markets, including modern data centers, to operate independently from the utility grid, while achieving high efficiency, reliability, and power quality.

There remains a need for a free-power turbine engine with both excellent transient behavior under block-loading conditions as well as excellent part-load efficiency over a wide power range.

### SUMMARY

These and other needs are addressed by the present disclosure of a multi-spool gas turbine engine incorporating a free power turbine (for example, as illustrated in FIG. 5). The free power turbine is, in some embodiments, fitted with a variable area nozzle to enable rapid response control of the gas flow and temperature at fractional power (for example, from about 15% to about 90% of full power). The free power turbine may be connected to a high speed alternator which, in turn, may be connected to an active rectifier. The DC output of the active rectifier may be connected by a DC link to an inverter which outputs regulated AC power. In some embodiments, the inverter is designed to produce grid-compatible power, typically at 50, 60 or 400 Hz. An energy storage device such as a battery or ultra-capacitor array may be connected to the DC link to provide a transient power boost when needed (For example, as illustrated in FIG. 6). Solar photovoltaic arrays or other renewable energy sources may also be connected to such a DC circuit.

A gas turbine configuration as disclosed herein exhibits exceptionally rapid transient response when presented with a rapid change in torque, such as a torque spike, characteristic of a rapid power increase from block loading. The following features are uniquely combined to provide the desired responsive behavior:

1. A free power turbine which characteristically provides increasing torque with decreasing speed (for example, as illustrated in FIG. 4B). A decrease in speed of the free power turbine tends to increase the mass flow rate through the gas turbine engine and accelerate the upstream turbines. This effect combined with a rapid increase in fuel supply tends to counteract the deceleration of the free power turbine:

2. A turbine shaft-speed alternator. A turbine shaft-speed alternator is a high speed alternator and, as such, is typically a low mass device and therefor will have a very high power density. The high-speed alternator would typically be a permanent magnetic type, an induction type, or a switched reluctance type.

3. The disclosed variable area nozzle (“VAN”) upstream of the free power turbine may be configured to open rapidly. Upon experiencing a torque spike, a VAN may open rapidly. This response provides a rapid increase in air flow aspirated by the engine. Combining this with a proportional increased fuel supply enables the power of the free power turbine to increase with a characteristic time constant close to that of the fuel valve and VAN movement.

4. A fast acting fuel valve. The valve may deliver natural gas or liquid fuel to the engine. An alternative to the valve is a variable speed natural gas compressor. The motor of the compressor may be connected to a variable frequency drive (“VFD”). An electronic signal sent to this VFD device may provide fast acting fuel control.

5. A fast-acting actuator driving the variable area turbine nozzle (“VAN”).

6. A multistage turbo-machine, whereby dividing the work of compression and expansion into multiple spools serves to lower an overall moment of inertia of the machine. This moment of inertia is often referred to as ‘turbo-lag’ in the field of turbochargers. Dividing the work of compression and expansion into multiple spools in a gas turbine has a similar transient behavior benefit.

7. Further reductions in the ‘turbo-lag’ phenomenon are achieved when one or both turbines are fabricated from light-weight ceramic materials.

8. Coupling a variable speed alternator to the free power turbine and coupling the rectified alternator output to an inverter whose impedance can be varied serves to isolate the speed change of the alternator from the frequency delivered to the power grid (the aforementioned 50, 60 or 400 Hz). This enables the engine to achieve high efficiency at part-power. When an electrical load is applied, starting from any power level, the instantaneous power demand may, first be met by the low inertia in the high-speed power turbine-alternator assembly and, if needed, by an ultra-capacitor. During transient of (for example, 1 to 4 seconds), the aforementioned power turbine may dip in speed, but recover rapidly owing to the behavior previously described. Throughout such a transient, the inverter may continue to deliver precisely the ISO quality frequency (50 or 60 Hz). A ‘blip’ in power may be made-up by the ultra-capacitor. A large battery may alternatively be used in some embodiments, but may require a power rating equal to that of the engine's generator, with large associated energy capacity and high cost. Preferably, a much smaller ultra-capacitor with capacity to deliver full engine-rated power for a few seconds which may be less expensive. A power turbine's behavior may be such that it changes speed quickly, drooping slightly but rapidly recovering. The integrated energy (power multiplies by time) may be very small, compared to what a typical battery would provide. The small stored energy may be most economically supplied by the ultra-capacitor. While in some block-load (or step-loads) the speed droop may not exceed ISO standards, for example 3% for <3 seconds, in larger load steps, the electrical capacitance can be drawn-upon to make up the power deficit, enabling the inverter to uphold the frequency, without noticeable change. For clarity, any perturbation on the output frequency line may be corrected in one or two cycles. (for example, ˜ 1/60^{th} of a second). Since the engine is able to deliver full power at sub-rated power turbine speed, the interruption in delivery of AC power to the grid is minimized; and

9. A small resistor bank, for example sized to provide the opposite feature of the aforementioned ultra-capacitor, may be used in instances when power (load) is dropped quickly. This resistor may be installed on the DC or AC link (FIG. 6).

The combined benefits of these nine features create a unique engine architecture with exceptionally agile transient behavior in an environment characterized by volatile load shifts.

Furthermore, as compared to the contemporary single shaft engine (as illustrated in FIGS. 1 and 2), the proposed engine architecture achieves exceptionally low emissions and high efficiency at part-load conditions. This is achieved by the engine's added degrees of control freedom. These degrees of control freedom are the VAN, the variable speed of the turbines (inverter controlled), and fuel valve. The conventional single shaft engine, currently used for block-loading, has only one degree of freedom: the fuel valve.

The proposed engine with three degrees of control freedom achieves exceptional efficiency by asserting control over the turbine inlet temperature at part-load. Maintaining high turbine inlet temperature maximizes the Carnot efficiency. Control over the turbine inlet temperature, or so-called firing temperature, improves combustor stability at part-load, thereby reducing carbon monoxide emissions and avoiding fuel piloting which tends to increase NOx emissions.

A gas turbine engine in some embodiments comprises one or more turbo-compressor spools wherein each spool comprises a compressor, a turbine, and a first rotatable shaft rotatably coupling the compressor and the turbine. The gas turbine engine further comprises a combustor for receiving a high-pressure airflow from the compressors of each of the turbo-compressor spools and delivering a heated airflow to the turbines of each of the turbo-compressor spools. The gas turbine engine further comprises a free turbine spool comprising a free turbine and a second rotatable shaft, the second rotatable shaft rotatably coupling the free turbine to one of a variable speed alternator and a generator, wherein the one of the variable speed alternator and the generator generates for the purpose of generating electrical power. The electrical output of the variable speed alternator or generator is delivered to an active rectifier. The inverter accepts the electrical power from the active rectifier and converts the electrical power to utility-quality frequency at 50, 60 or 400 Hz. The gas turbine engine further comprises a recuperator and a variable area nozzle on the free power turbine. The gas turbine engine further comprises a fast-acting actuator controlling the variable area nozzle; an intercooler between the compressor of the first turbo-compressor spool of the one or more spools and the compressor of the second turbo-compressor spool of the one or more spools and one or more ultra-capacitors connected to a DC link between the active rectifier and the inverter, wherein the capacitors are operable to provide a pulse of DC power upon detection of a block loading event.

A method of operating a gas turbine engine is disclosed wherein the method comprises receiving, by a combustor of the gas turbine engine, a high-pressure air flow from a compressor of each of one or more turbo-compressor spools, wherein each spool of the one or more spools comprises a compressor, a turbine, and a first rotatable shaft rotatably coupling the compressor and the turbine; delivering a heated airflow to the turbine of each of the spools, wherein the airflow rotatably drives the first rotatable shaft and the compressor of each of the turbo-compressor spools; generating, by one of a variable speed alternator and a generator, electrical power, wherein the one of the variable speed alternator and the generator is rotatably coupled to a free turbine spool comprising a free turbine and a second rotatable shaft; accepting, by an inverter, the electrical power from an active rectifier; and converting, by the inverter, the electrical power to utility-quality frequency. The method of operating a gas turbine whereby the gas turbine engine further comprises a heat exchanger and a variable area nozzle with a fast-acting actuator on the free turbine. The method of operating a gas turbine engine whereby the gas turbine engine further comprises an intercooler between a compressor of a first turbo-compressor spool of the one or more spools and a compressor of a second turbo-compressor spool of the one or more spools. The method of operating a gas turbine engine providing, by one or more ultra-capacitors connected to a DC link between the active rectifier and the inverter, a pulse of DC power upon detection of a block loading event wherein the utility-quality frequency is one of 50, 60, and 400 Hz.

A system for overcoming effects of turbo lag on a block loaded gas turbine engine is disclosed, the system comprising a gas turbine engine having one or more turbo-compressor spools, wherein each turbo-compressor spool has a compressor, a turbine, and a first rotatable shaft rotatably coupling the compressor and the turbine. The gas turbine engine also has a combustor for receiving a high-pressure airflow from the compressor of each of the turbo-compressor spools and delivers a heated airflow to the turbine of each of the turbine-compressor spools, wherein the airflow rotatably drives the first rotatable shaft and the compressor of each of the turbine-compressor spools. The system further comprises a free turbine spool comprising a free turbine and a second rotatable shaft, the second rotatable shaft rotatably coupling the free turbine to one of a variable speed alternator and a generator, wherein the one of the variable speed alternator and the generator generates electrical power. The system further comprises an active rectifier; and an inverter accepting the electrical power from the active rectifier wherein the electrical power from the inverter is converted to utility-quality frequency. The system further comprises a recuperator and a variable area nozzle on the free turbine. The system may further comprise an intercooler between a compressor of a first spool of the one or more spools and a compressor of a second spool of the one or more spools. The system further comprises one or more ultra-capacitors connected to a DC link between the active rectifier and the inverter, wherein the capacitors provide a pulse of DC power upon detection of a block loading event and wherein the system maintains an output of utility-quality frequency that is one of 50, 60, and 400 Hz.

The above-described embodiments and configurations are neither complete nor exhaustive. As will be appreciated, other embodiments of the disclosure are possible utilizing, alone or in combination, one or more of the features set forth above or described in detail below.

The following definitions are used herein:

The phrases at least one, one or more, and and/or are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

An alternator is an electrical generator that converts mechanical energy to electrical energy in the form of alternating current.

Block loading means suddenly increasing load to an electrical generator set. Block loading causes a sudden reduction of the engine speed with resulting fluctuating power output from the generator. Block loading occurs when an engine, such as a diesel engine, gas turbine engine or the like, is driving an electrical generator and the generator set experiences a sudden increase in load due to a planned requirement. Block loading usually occurs when an external electrical load is applied suddenly to the generator. The generator will attempt to provide for the increase in electrical power demand by drawing more mechanical power from the engine and converting the additional mechanical power to electrical power. As a result of the increase of mechanical load, the engine may reduce the rotational speed of the drive shaft as the resistance on the shaft increases. Until additional fuel and air can be directed into the engine, the engine compensates by producing a higher output of mechanical power required by the generator and tries to recover. That means that block loading causes a temporary increase of fuel consumption. If block loading occurs, it can cause the electrical power output of the generator to waver. This is important for the use of the generator set, because the variation in a frequency may affect the speed of, for example, an electrical motor that is needed in a process where it is very important to have constant speed on the shaft of the electric motor.

The Brayton cycle is a thermodynamic cycle that describes the workings of the gas turbine engine. It is named after George Brayton, the American engineer who developed it. It is also sometimes known as the Joule cycle. The ideal Brayton cycle consists of an isentropic compression process followed by an isobaric combustion process where fuel is burned, then an isentropic expansion process where the energized fluid gives up its energy to operate compressors or produce engine power and lastly an isobaric process where low grade heat is rejected to the atmosphere. An actual Brayton cycle consists of an adiabatic compression process followed by an isobaric combustion process where fuel is burned, then an adiabatic expansion process where the energized fluid gives up its energy to operate compressors or produce engine power and lastly an isobaric process where low grade heat is rejected to the atmosphere.

A ceramic is an inorganic, nonmetallic solid prepared by the action of heating and cooling. Ceramic materials may have a crystalline or partly crystalline structure, or may be amorphous (e.g., a glass).

Design point as used herein means the engine speed or power at which optimum fuel efficiency and/or thermodynamic efficiency is achieved.

The terms determine, calculate and compute and variations thereof are used interchangeably and include any type of methodology, process, mathematical operation or technique.

An engine is a prime mover and refers to any device that uses energy to develop mechanical power, such as motion in some other machine. Examples are diesel engines, gas turbine engines, microturbines, Stirling engines and spark ignition engines.

A free power turbine as used herein is a turbine which is driven by a gas flow and whose rotary power is the principal mechanical output power shaft. A free power turbine is not connected to a compressor in the gasifier section. A power turbine may also be connected to a generator or alternator. Typically the low speed generator operates at a speed synchronized to the utility (for example, 50 Hz, 60 Hz). This connection is generally made through a gearbox to allow the turbine and generator to operate at separate speeds. So-called high speed, or shaft-speed alternators operate at the turbine rotational speed. In this case, electronic conversion devices are required to synthesize utility grade power.

Fuel piloting means using a pilot fuel line to provide a rich diffusion flame which is always on and which enables the engine to keep functioning at low engine speeds. In a gas turbine engine, the main fuel supply is pre-mixed for low emissions.

A gas turbine engine as used herein may also be referred to as a turbine engine or microturbine engine. A microturbine is commonly a sub category under the class of prime movers called gas turbines and is typically a gas turbine with an output power in the approximate range of about a few kilowatts to about 700 kilowatts. A turbine or gas turbine engine is commonly used to describe engines with output power in the range above about 700 kilowatts. As can be appreciated, a gas turbine engine can be a microturbine since the engines may be similar in architecture but differing in output power level. The power level at which a microturbine becomes a turbine engine is arbitrary and the distinction has no meaning as used herein.

A gasifier is a turbine-driven compressor in a gas turbine engine dedicated to compressing air that, once heated, is expanded through a power turbine to produce energy.

In electrical generation, a generator is a device that converts mechanical energy into electrical power for use in an external circuit.

The grid or grid power as used herein is a term used for an electricity network which may support some or all of electricity generation, electric power transmission and electricity distribution. The grid may be used to refer to an entire continent's electrical network, a regional transmission network or may be used to describe a subnetwork such as a local utility's transmission grid or distribution grid. Generating plants may be large or small and may be located at various points around the grid. The electric power which is generated is stepped up to a higher voltage—at which it connects to the transmission network. The transmission network may move (wheel) the power long distances until it reaches a wholesale customer (for example the company that owns the local distribution network). Upon arrival at the substation, the power may be stepped down in voltage—from a transmission level voltage to a distribution level voltage. As the power exits the substation, it enters the distribution wiring. Finally, upon arrival at the service location, the power is stepped down again from the distribution voltage to the required service voltage(s). Existing national or regional grids simply provide the interconnection of facilities to utilize whatever redundancy is available. The exact stage of development at which the supply structure becomes a grid is arbitrary. Similarly, the term national grid is something of an anachronism in many parts of the world, as transmission cables now frequently cross national boundaries. Utilities are under pressure to evolve their classic topologies to accommodate distributed generation. As generation becomes more common from rooftop solar and wind generators, the differences between distribution and transmission grids will continue to blur.

An intercooler as used herein may comprise a heat exchanger positioned between the output of a compressor of a gas turbine engine and the input to a higher pressure compressor of a gas turbine engine. Air, or in some configurations, an air-fuel mix is introduced into a gas turbine engine and its pressure is increased by passing through at least one compressor. The working fluid of the gas turbine then passes through the hot side of the intercooler and heat is removed typically by an ambient fluid such as, for example, air or water flowing through the cold side of the intercooler.

The term means shall be given its broadest possible interpretation in accordance with 35 U.S.C., Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary of the disclosure, brief description of the drawings, detailed description, abstract, and claims themselves.

A metallic material is a material containing a metal or a metallic compound. A metal refers commonly to alkali metals, alkaline-earth metals, radioactive and non-radioactive rare earth metals, transition metals, and other metals.

A prime power source refers to any device that uses energy to develop mechanical or electrical power, such as motion in some other machine. Examples are diesel engines, gas turbine engines, microturbines, Stirling engines, spark ignition engines and fuel cells.

Power density as used herein is power per unit volume (watts per cubic meter).

A recuperator is a heat exchanger dedicated to returning exhaust heat energy from a process back into the process to increase process efficiency. In a gas turbine thermodynamic cycle, heat energy is transferred from the turbine discharge to the combustor inlet gas stream, thereby reducing heating required by fuel to achieve a requisite firing temperature.

A single shaft gas turbine engine is comprised of a single shaft for its compressor, turbine and output alternator.

Specific power as used herein is power per unit mass (watts per kilogram).

Spool refers to a group of turbo-machinery components on a common shaft.

Spool speed as used herein means spool shaft rotational speed which is typically expressed in revolutions per minute (“rpms”). As used herein, spool rpms and spool speed may be used interchangeably.

A turbine is a rotary machine in which mechanical work is continuously extracted from a moving fluid by expanding the fluid from a higher pressure to a lower pressure. The simplest turbines have one moving part, a rotor assembly, which is a shaft or drum with blades attached. Moving fluid acts on the blades, or the blades react to the flow, so that they move and impart rotational energy to the rotor.

Turbine Inlet Temperature (TIT) as used herein refers to the gas temperature at the outlet of the combustor which is closely connected to the inlet of the high pressure turbine and these are generally taken to be the same temperature.

Turbocharger-like architecture or turbocharger technology means spools which are derived from modified stock turbocharger hardware components. In an engine where a centrifugal turbine with a ceramic rotor is used, the tip speed of the rotor is held to a proven allowable low limit (<500 m/s). Centrifugal compressors and radial inlet turbines are typically used in turbocharger applications.

A turbo-compressor spool assembly as used herein refers to an assembly typically comprised of an outer case, a centrifugal compressor, a radial inlet turbine wherein the centrifugal compressor and radial inlet turbine are attached to a common shaft. The assembly also includes inlet ducting for the compressor, a compressor rotor, a diffuser for the compressor outlet, a volute for incoming flow to the turbine, a turbine rotor and an outlet diffuser for the turbine. The shaft connecting the compressor and turbine includes a bearing system.

A two-shaft engine, also known as free-power turbine engine, as used herein comprises a turbine which is driven by a gas flow and whose rotary power is the principal mechanical output power shaft. A free power turbine is not connected to a compressor in the gasifier section, although the free power turbine may be in the gasifier section of the gas turbine engine.

An ultra-capacitor (also called a super capacitor) is a capacitor with capacitance value much higher than other capacitors, but usually with a lower voltage limit, that bridges the gap between electrolytic capacitors and rechargeable batteries. An ultra-capacitor typically stores 10 to 100 times more energy per unit volume or mass than electrolytic capacitors, can accept and deliver charge much faster than batteries, and tolerate many more charge and discharge cycles than rechargeable batteries.

### BRIEF DESCRIPTION OF THE DRAWINGS

The present disclosure may take form in various components and arrangements of components, and in various steps and arrangements of steps. The drawings are only for purposes of illustrating the preferred embodiments and are not to be construed as limiting the disclosure. In the drawings, like reference numerals refer to like or analogous components throughout the several views.

FIG. 1 is a schematic of a prior art recuperated single shaft gas turbine engine with gearbox and electrical generator.

FIG. 2 is a schematic of a prior art recuperated single shaft gas turbine engine with electrical generator and inverter.

FIG. 3 is a schematic of a prior art recuperated multi-spool gas turbine engine with gearbox and electrical generator.

FIG. 4A shows engine output torque versus engine speed for a reciprocating engine and a single shaft gas turbine engine under normal operating conditions.

FIG. 4B shows engine output torque versus engine speed for a free power gas turbine engine under normal operating conditions.

FIG. 5 is a schematic of a recuperated multi-spool gas turbine engine with a variable are nozzle at the input to the free power turbine and with the free power turbine driving an electrical generator and inverter.

FIG. 6 is a schematic of an electrical power conditioning arrangement for improved transient response.

### DETAILED DESCRIPTION

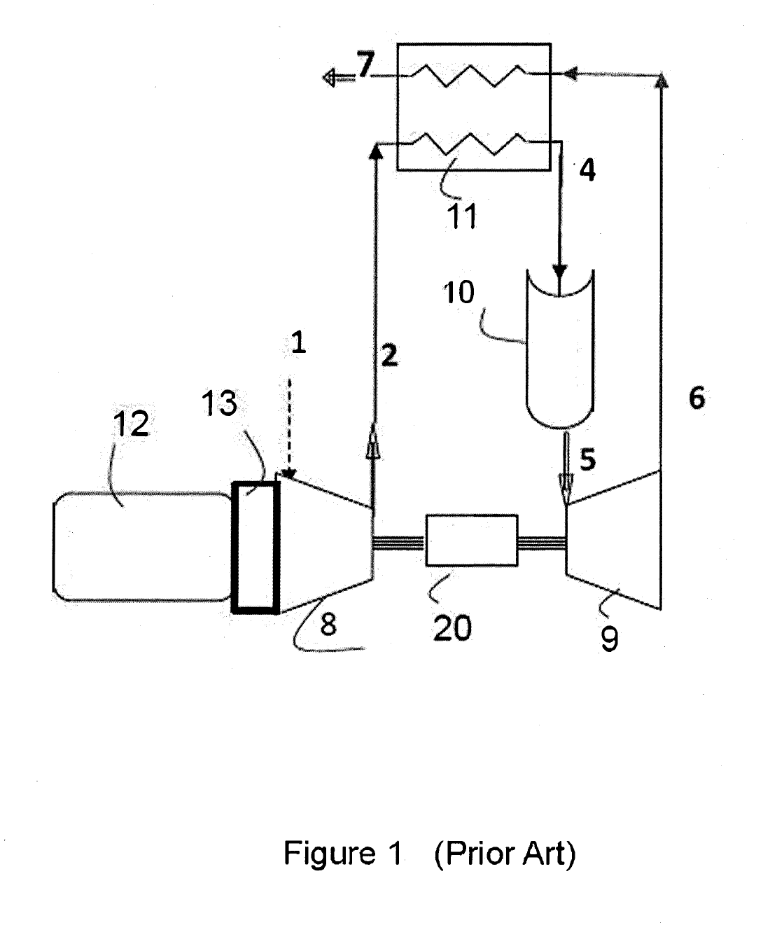

FIG. 1 is a schematic of a prior art recuperated single shaft gas turbine engine with gearbox and electrical generator. This single shaft gas turbine comprises an inlet 1 to compressor 8. The output 2 from compressor 8 passes through the cold side of recuperator 11 where it acquires heat from the hot side of recuperator 11. The heated output 4 of the cold side of recuperator 11 then enters combustor 10 where air is combusted with fuel. The combusted gas 5 then flows into turbine 9 which powers shaft 20 and compressor 8. The gas flow 6 exiting turbine 9 flows through the hot side of recuperator 11 and exits through exhaust 7 to the atmosphere. In addition to compressor 8, shaft 20 also drives gearbox 13 and synchronous generator 12. In a single shaft gas turbine engine such as shown in FIG. 1, the synchronous generator is driven by the same shaft as the turbo-compressor spool. Thus rotary speed of the engine is the same as the rotary speed of the synchronous generator.

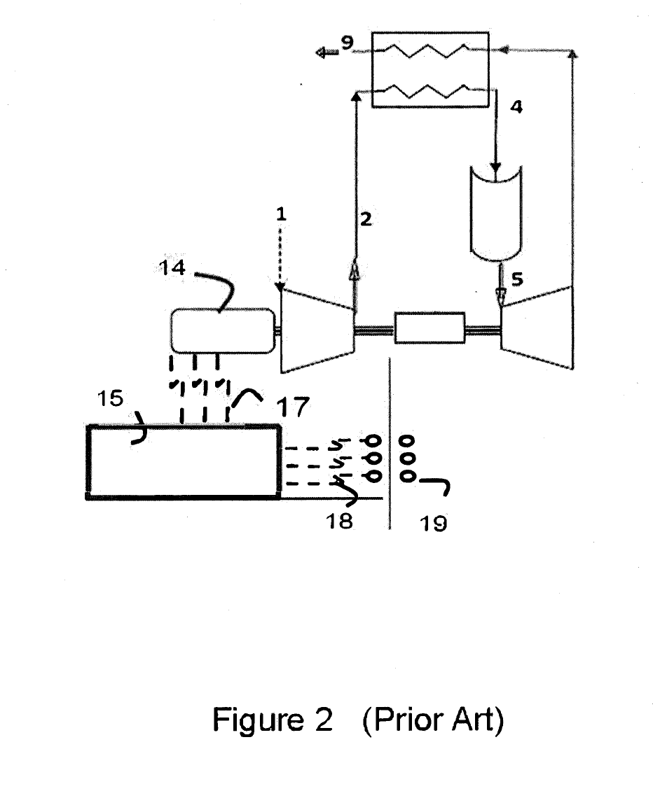

FIG. 2 is a schematic of a prior art recuperated single shaft gas turbine engine with electrical generator and inverter. FIG. 2 shows the same single shaft gas turbine as FIG. 1 with a variable speed alternator 14 on the same shaft as the turbine of the turbo-compressor spool. The variable speed alternator 14 drives power electronics 15. As in FIG. 1, the rotary speed of the engine is the same as the rotary speed of the electrical generator.

The single shaft gas turbine engines shown in FIGS. 1 and 2 have one degree of control which is control of the fuel valve for the engine's main fuel flow.

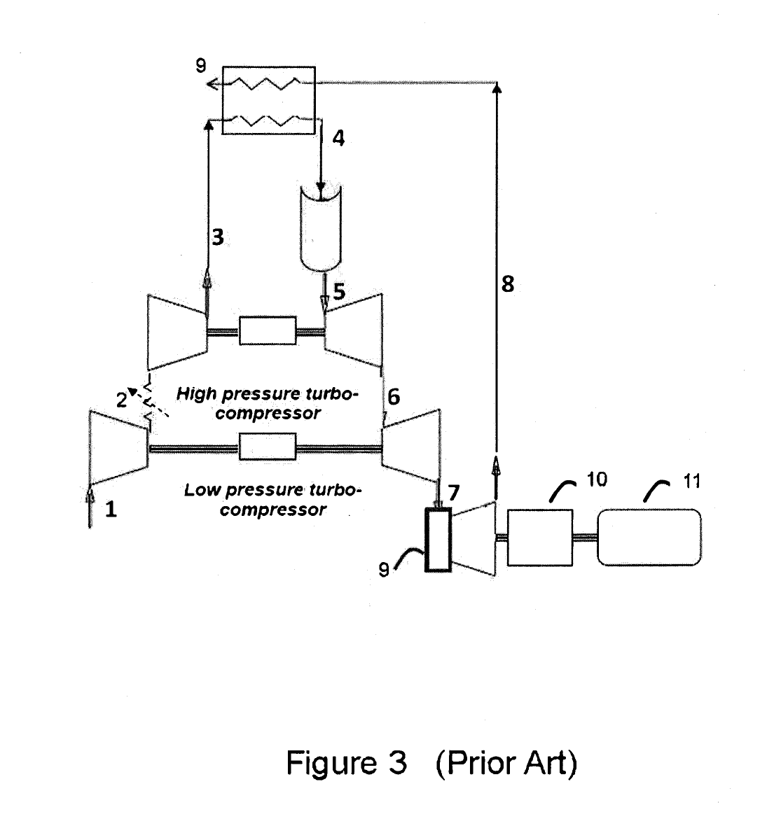

FIG. 3 is a schematic of a prior art recuperated multi-spool gas turbine engine with gearbox and electrical generator showing the component arrangement and gas flow paths of a prior art intercooled, recuperated gas turbine engine architecture that operates in the 10 kW to approximately 650 kW range with peak thermal efficiencies above about 40%.

As shown in FIG. 3, gas is ingested at inlet 1 into a low pressure compressor. The outlet of the low pressure compressor flows along path 2 and passes through an intercooler which removes a portion of heat from the gas stream at approximately constant pressure. The gas then enters a high pressure compressor. The outlet of high pressure compressor flows along path 3 and enters the cold side of a recuperator where a portion of heat from the exhaust gas is transferred at approximately constant pressure to the gas flow from the high pressure compressor. The further heated gas from the cold side of recuperator is then directed along path 4 to a combustor where a fuel is burned, adding heat energy to the gas flow at approximately constant pressure. The gas emerging from the combustor then flows along path 5 and enters a high pressure turbine where work is done by the turbine to operate the high pressure compressor. The gas from the high pressure turbine then flows along path 6 and enters low pressure turbine where work is done by turbine to operate the low pressure compressor. The gas exiting from low pressure turbine then flows along path 7 through the variable area nozzle 8 to drive the free power turbine. The shaft of free power turbine, in turn, drives a transmission 10 which transmits power to electrical generator 11. Alternately, the shaft of the free power turbine can directly drive an electrical generator or high speed alternator. Finally, the gas exiting free power turbine flows along path 8 through the hot side of the recuperator where heat is extracted and used to preheat the gas on the cold side of the recuperator. The gas exiting the hot side of the recuperator is then exhausted on path 9 to the atmosphere. This engine design is described, for example, in U.S. patent application Ser. No. 12/115,134 filed May 5, 2008, entitled “Multi-Spool Intercooled Recuperated Gas Turbine” which is incorporated herein by this reference.

In the gas turbine engine of FIG. 3, the rotary speed of the two turbo compressor spools is decoupled from the rotary speed of the free power turbine and electrical generator or alternator.

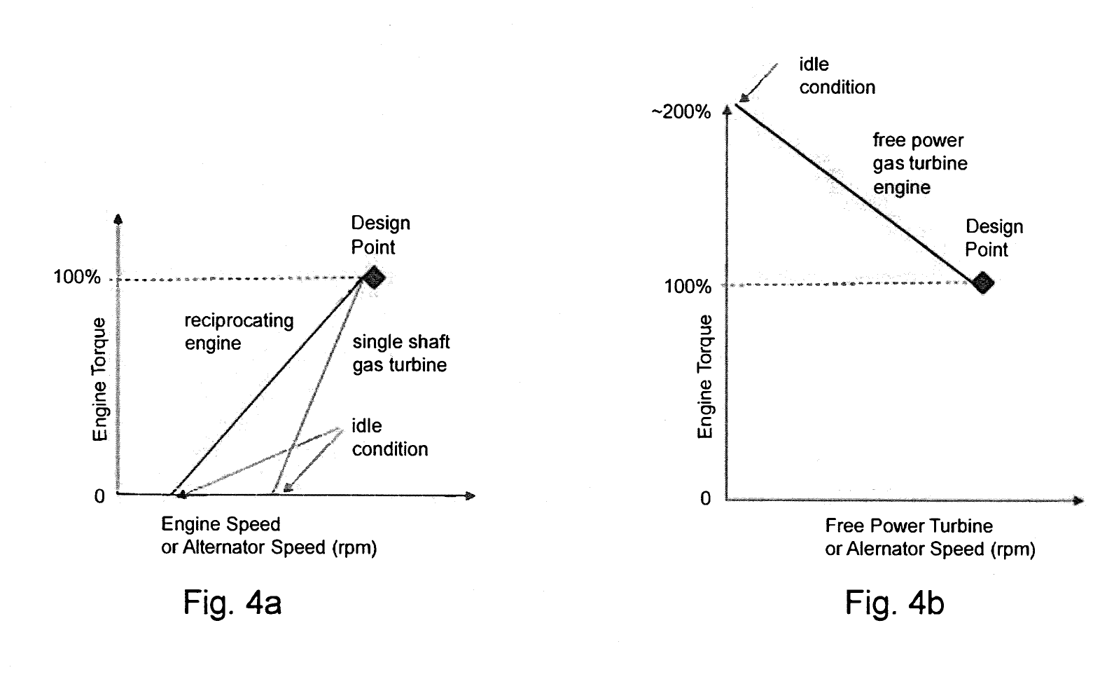

FIG. 4 shows an example of engine output torque versus engine speed for a reciprocating engine and a single shaft gas turbine engine under normal operating conditions. For both the reciprocating engine and the single shaft gas turbine engine, engine speed and alternator speed may be the same from idle to the design point. The design point as used herein means the engine speed or power at which optimum fuel efficiency is achieved. The output torque of the engine is 100% at the design point.

FIG. 4B shows engine output torque versus engine speed for a free power gas turbine engine under normal operating conditions. For the free power gas turbine engine, engine speed is decoupled from the speed of the free power turbine and alternator. As free power turbine speed decreases under increased electrical load, engine torque increases as the turbo compressor spools continue to generate mass flow resisting the deceleration of the free power turbine.

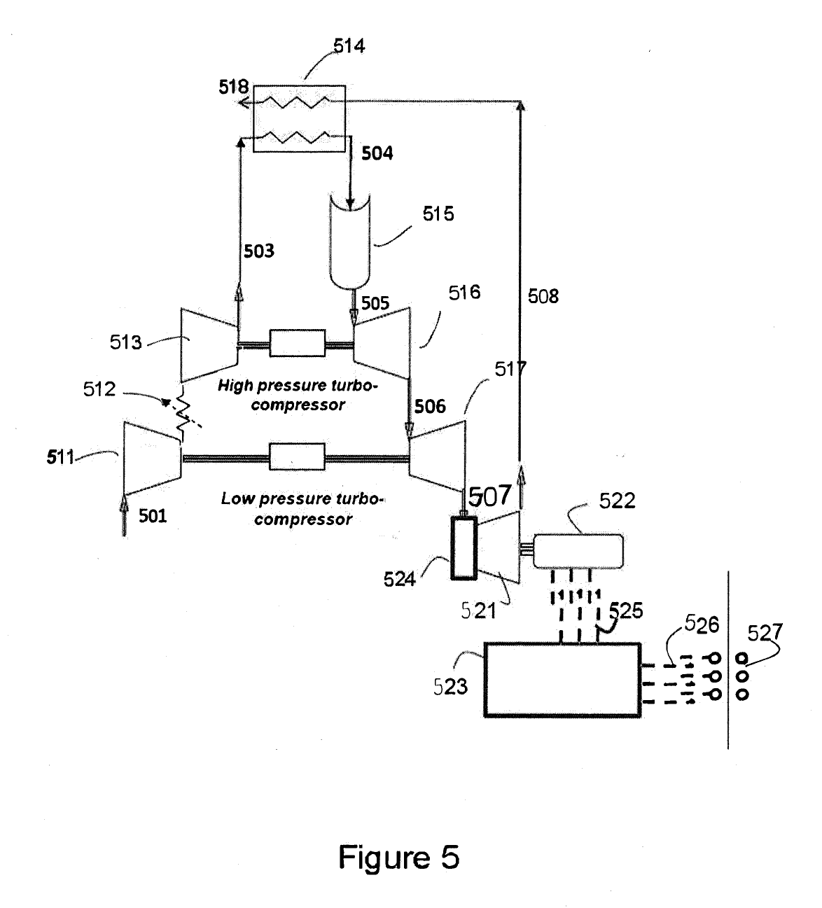

FIG. 5 is a schematic of a recuperated multi-spool gas turbine engine with a variable are nozzle at the input to the free power turbine and with the free power turbine driving an electrical generator and inverter. FIG. 5 illustrates a turbo-machine of the present disclosure comprised of three independent spools. Two independent spools are in some embodiments nested turbo-compressor spools (a low pressure and a high pressure turbo compressor spool) and one spool may be a free power turbine spool connected to a load device. As illustrated in FIG. 5, the low pressure spool is comprised of a compressor 511 and a turbine 517. The high pressure spool is comprised of a compressor 513 and a turbine 516. The free power turbine spool is comprised of a turbine 521 and a variable area nozzle 524. The free power turbine 521 drives a variable speed alternator 522 which, in turn, is connected to power electronics module 523.

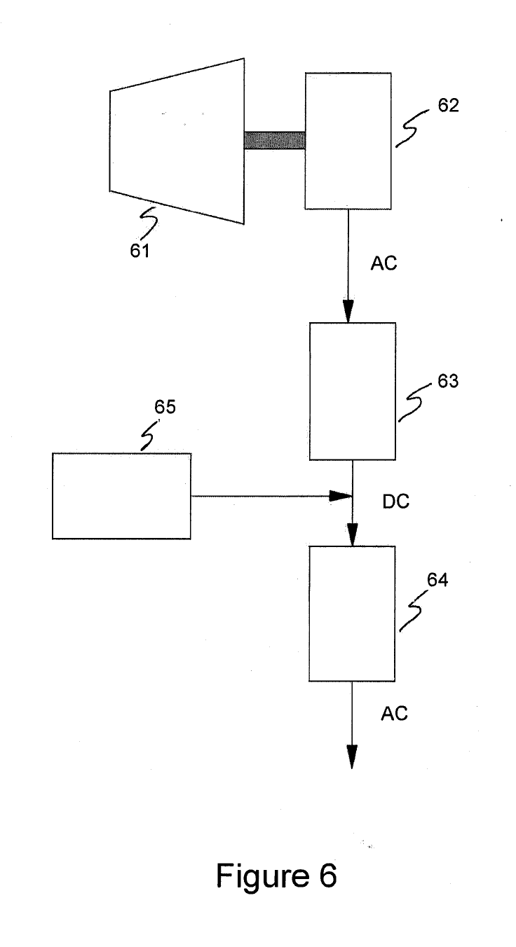

Gas is ingested via inlet 501 into a low pressure compressor 511. The outlet of the low pressure compressor 511 passes through an intercooler 512 which removes a portion of heat from the gas stream. The gas then enters a high pressure compressor 513. The outlet 503 of high pressure compressor 513 passes through the cold side of a recuperator 514 where a portion of heat from the exhaust gas is transferred to the gas flow from the high pressure compressor 513. The further heated gas 504 from the cold side of recuperator 514 is then directed to a combustor 515 where a fuel is burned, adding heat energy to the gas flow. The gas 505 emerging from the combustor 515 then enters a high pressure turbine 516 where work is done by turbine 516 to operate high pressure compressor 513. The gas 506 from the high pressure turbine 513 then drives low pressure turbine 517 where work is done by turbine 517 to operate low pressure compressor 511. The gas 507 exiting from low pressure turbine 517 then passes through variable area nozzle 524 and enters free power turbine 521. The shaft of free power turbine 512, in turn, drives a variable speed alternator 522. The variable speed alternator 522 delivers AC power to power electronics module 523 as further described in FIG. 6. Finally, the gas 508 exiting free power turbine 521 flows through the hot side of the recuperator 514 where heat is extracted and used to preheat the gas just prior to entering the combustor 515. The gas 518 exiting the hot side of recuperator 514 is then exhausted via exhaust port 518 to the atmosphere.

The proposed configuration of FIG. 5 incorporates a multi-spool gas turbine with a free power turbine 521. The free power turbine 521 is fitted with a variable area nozzle 524 to enable rapid control over the air flow and temperature at fractional power. The free power turbine 521 is connected to a high-speed alternator 522. The electrical output from alternator 522 is connected to an active rectifier which is connected to an electrical inverter 523 by cabling 525. The inverter is designed to produce grid-compatible power 526, for example at 50, 60 or 400 Hz and may output such power to a grid 527.

The gas turbine configuration of FIG. 5 exhibits exceptionally fast transient response when presented with a step-change in torque, characteristic of a rapid electrical power increase. The following features are uniquely combined to provide the desired responsive behavior.

1. The free power turbine which characteristically provides increasing torque with decreasing speed (FIG. 4B). A decrease in speed of the free power turbine tends to increase the mass flow rate through the gas turbine engine and accelerate the upstream turbines. This effect combined with a rapid increase in fuel supply tends to counteract the deceleration of the free power turbine

2. A turbine shaft-speed alternator. A turbine shaft-speed alternator is a high speed alternator and, as such, it is typically a low mass device and therefor will have a very high power density. The high-speed alternator would typically be a permanent magnetic type, an induction type, or a switched reluctance type.

3. The proposed variable area nozzle (“VAN”) upstream of the free power turbine is configured to open rapidly. Upon experiencing the torque spike, this VAN is opened rapidly. This provides a rapid an increase in air flow aspirated by the engine. Combining this with a proportional increased fuel supply enables the power of the free power turbine to increase with a characteristic time constant close to that of the fuel valve and VAN movement.

4. A fast acting fuel valve. The valve may deliver natural gas or liquid fuel to the engine. An alternative to the valve is a variable speed natural gas compressor. The motor of the compressor may be connected to a variable frequency drive (“VFD”). An electronic signal sent to this VFD device would provide fast acting fuel control.

5. A fast-acting actuator driving the variable area turbine nozzle (“VAN”).

6. A multistage turbo-machine, whereby dividing the work of compression and expansion into multiple spools, serves to lower the overall moment of inertia of the machine. This moment of inertia is often referred to as ‘turbo-lag’ in the field of turbochargers. Dividing the work of compression and expansion into multiple spools in a gas turbine has a similar transient behavior benefit.

7. Further reductions in the ‘turbo-lag’ phenomenon are achieved when one or both turbines are fabricated from light-weight ceramic materials.

8. Coupling a variable speed alternator to the free power turbine and coupling the rectified alternator output to an inverter whose impedance can be varied, serves to isolate the speed change of the alternator from the frequency delivered to the power grid (the aforementioned 50, 60 or 400 Hz). This enables the engine to achieve high efficiency at part-power. When an electrical load is applied, starting from any power level, the instantaneous power demand is met first by the low inertia in the high-speed power turbine-alternator assembly, and if needed, by the ultra-capacitor. During that the short transient of 1 to 4 seconds, the aforementioned power turbine dips in speed, but recovers rapidly owing to the behavior previously described. Throughout this transient, the inverter continues to deliver precisely the ISO quality frequency (50 or 60 Hz). The ‘blip’ in power may be made-up by the ultra-capacitor. A large battery might also be used, but it would require a power rating equal to that of the engine's generator, with large associated energy capacity and high cost. Preferably a much smaller ultra-capacitor with capacity to deliver full engine rated power for a few seconds would be less expensive. The power turbine's behavior is such that it changes speed quickly, drooping slightly but rapidly recovering. The integrated energy (power times time) is very small, compared to what a typical battery would provide. The small stored energy is most economically supplied by the ultra-capacitor. While in some block-load (or step-loads) the speed droop may not exceed ISO standards, typically 3% for <3 seconds, in larger load steps, the electrical capacitance can be drawn-upon to make up the power deficit, enabling the inverter to uphold the frequency, without noticeable change. For clarity, any perturbation on the output frequency line would be corrected in one or two cycles. (˜ 1/60^{th} of a second). Since the engine is able to deliver full power at sub-rated power turbine speed, the interruption in delivery of AC power to the grid is minimized.

9. A small resistor bank, typically sized to provide the opposite feature of the aforementioned ultra-capacitor, may be used in instances when power (load) is dropped quickly. This resistor may be installed on the DC or AC link (FIG. 6).

The combined benefits of these eight features create a unique engine architecture with exceptionally agile transient behavior in an environment characterized by volatile load shifts.

Furthermore, as compared to the contemporary single shaft engine (FIG. 1), the proposed engine architecture (FIG. 5) achieves exceptional emissions and efficiency at part-load conditions. This is achieved by the engine's added degrees of control freedom; that being the VAN, the variable speed of the turbines (inverter controlled), and fuel valve. The state of the art single shaft engine, currently used for block-loading, has only one degree of freedom: the fuel valve.

The gas turbine engine shown in FIG. 5 has three degrees of control freedom. These are:

control of the fuel valve for the engine's main fuel flow;

control of the variable area nozzle at the entrance of the free power turbine; and

control of inverter impedance which controls the rpms of the free power turbine.

The proposed gas turbine engine shown in FIG. 5 with three degrees of control freedom achieves exceptional efficiency by asserting control over the turbine inlet temperature at part-load. Maintaining high turbine inlet temperature maximizes the Carnot efficiency. Control over the turbine inlet temperature, or so-called firing temperature, improves combustor stability at part-load, thereby reducing carbon monoxide emissions and avoiding fuel piloting which tends to increase NOx emissions.

FIG. 6 is a schematic of an electrical power conditioning arrangement for improved transient response in accordance with one or more embodiments and based on the gas turbine engine shown in FIG. 5. A free power turbine 61 may be connected to a high speed alternator 62 which, in turn, may be connected to an active rectifier 63. The DC output of the active rectifier 63 may be connected by a DC link to an inverter 64 which outputs regulated AC power. The inverter 64 is designed to produce grid-compatible power, typically at 50, 60 or 400 Hz. An energy storage device 65 such as a battery or ultra-capacitor array may be connected to the DC link connecting active rectifier 63 to inverter 64 to provide a transient power boost when needed.

For example, when the energy storage device is an ultra-capacitor or array of ultra-capacitors, the capacitator or capacitors can be rapidly discharged when a block loading event demanding more power is detected. This rapid injection of electrical power will maintain the required power level while the gas turbine engine is responding, thus further reducing turbo lag and maintaining output power within ISO requirements.

The disclosure has been described with reference to the preferred embodiments. Modifications and alterations will occur to others upon a reading and understanding of the preceding detailed description. It is intended that the disclosure be construed as including all such modifications and alterations insofar as they come within the scope of the appended claims or the equivalents thereof.

A number of variations and modifications of the disclosures can be used. As will be appreciated, it would be possible to provide for some features of the disclosures without providing others.

The present disclosure, in various embodiments, includes components, methods, processes, systems and/or apparatus substantially as depicted and described herein, including various embodiments, sub-combinations, and subsets thereof. Those of skill in the art will understand how to make and use the present disclosure after understanding the present disclosure. The present disclosure, in various embodiments, includes providing devices and processes in the absence of items not depicted and/or described herein or in various embodiments hereof, including in the absence of such items as may have been used in previous devices or processes, for example for improving performance, achieving ease and\or reducing cost of implementation.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more embodiments for the purpose of streamlining the disclosure. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment. Thus, the following claims are hereby incorporated into this Detailed Description, with each claim standing on its own as a separate preferred embodiment of the disclosure.

Moreover though the description of the disclosure has included description of one or more embodiments and certain variations and modifications, other variations and modifications are within the scope of the disclosure, e.g., as may be within the skill and knowledge of those in the art, after understanding the present disclosure. It is intended to obtain rights which include alternative embodiments to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A gas turbine engine, comprising:
one or more turbo-compressor spools each spool having a compressor, a turbine, and a first rotatable shaft rotatably coupling the compressor and the turbine;
a combustor for receiving a high-pressure airflow from the compressors of each of the turbo-compressor spools and delivering a heated airflow to the turbines of each of the turbo-compressor spools;
a free turbine spool comprising a free turbine and a second rotatable shaft, the second rotatable shaft rotatably coupling the free turbine to one of a variable speed alternator and a generator, wherein the one of the variable speed alternator and the generator generates for the purpose of generating electrical power; and
an active rectifier accepting a variable frequency output from one of a variable speed alternator and a generator, converting AC power to DC power, and delivering the DC the electrical power to an inverter for conversion of the electrical power at utility quality fixed output frequency.

2. The gas turbine engine of claim 1, further comprising:
a recuperator; and
a variable area nozzle on the free power turbine.

3. The gas turbine engine of claim 1, further comprising a fast-acting actuator controlling the variable area nozzle.

4. The gas turbine engine of claim 1, further comprising:
an intercooler between the compressor of the first turbo-compressor spool of the one or more spools and the compressor of the second turbo-compressor spool of the one or more spools.

5. The gas turbine engine of claim 1, further comprising:
one or more ultra-capacitors connected to a DC link between the active rectifier and the inverter, wherein the ultra-capacitors are operable to provide a pulse of DC power upon detection of a block loading event.

6. The gas turbine engine of claim 1, wherein the utility-quality frequency is one of 50, 60, and 400 Hz.

7. A method of operating a gas turbine engine, the method comprising:
receiving, by a combustor of the gas turbine engine, a high-pressure air flow from a compressor of each of one or more turbo-compressor spools, wherein each spool of the one or more spools comprises a compressor, a turbine, and a first rotatable shaft rotatably coupling the compressor and the turbine;
delivering a heated airflow to the turbine of each of the spools, wherein the airflow rotatably drives the first rotatable shaft and the compressor of each of the turbo-compressor spools;
generating, by one of a variable speed alternator and a generator, electrical power, wherein the one of the variable speed alternator and the generator is rotatably coupled to a free turbine spool comprising a free turbine and a second rotatable shaft;
accepting, by an inverter, the electrical power from an active rectifier; and
converting, by the inverter, the electrical power to utility-quality frequency.

8. The method of claim 7, wherein the gas turbine engine of further comprises:
a heat exchanger; and
a variable area nozzle on the free turbine.

9. The method of claim 7, further comprising driving the variable area nozzle with a fast-acting actuator.

10. The method of claim 7, wherein the gas turbine engine of further comprises:
an intercooler between a compressor of a first turbo-compressor spool of the one or more spools and a compressor of a second turbo-compressor spool of the one or more spools.

11. The method of claim 7, further comprising:
providing, by one or more ultra-capacitors connected to a DC link between the active rectifier and the inverter, a pulse of DC power upon detection of a block loading event.

12. The method of claim 7, wherein the utility-quality frequency is one of 50, 60, and 400 Hz.

13. A system for overcoming effects of turbo lag on a block loaded gas turbine engine, the system comprising:
the gas turbine engine having one or more turbo-compressor spools, wherein each turbo-compressor spool has a compressor, a turbine, and a first rotatable shaft rotatably coupling the compressor and the turbine;
the gas turbine engine having a combustor for receiving a high-pressure airflow from the compressor of each of the turbo-compressor spools and delivering a heated airflow to the turbine of each of the turbine-compressor spools, wherein the airflow rotatably drives the first rotatable shaft and the compressor of each of the turbine-compressor spools;
the gas turbine engine having a free turbine spool comprising a free turbine and a second rotatable shaft, the second rotatable shaft rotatably coupling the free turbine to one of a variable speed alternator and a generator, wherein the one of the variable speed alternator and the generator generates electrical power;
the gas turbine engine having an active rectifier; and
the gas turbine engine having an inverter accepting the electrical power from the active rectifier and converting the electrical power to utility-quality frequency.

14. The system of claim 13, the gas turbine engine further comprising:
a heat exchanger; and
a variable area nozzle on the free turbine.

15. The system of claim 13, the gas turbine engine further comprising:
an intercooler between a compressor of a first spool of the one or more spools and a compressor of a second spool of the one or more spools.

16. The system of claim 13, the gas turbine further comprising:
one or more ultra-capacitors connected to a DC link between the active rectifier and the inverter, wherein the capacitors provide a pulse of DC power upon detection of a block loading event.

17. The system of claim 13, wherein the utility-quality frequency is one of 50, 60, and 400 Hz.
